(19) United States
(12) Patent Application Publication
(10) Pub. No.: US 2019/0155029 A1
(43) Pub. Date: May 23, 2019

(54) Vehicular Head-Up Display Using Geometrical Optical Structure to Shield Ambient Light

(71) Applicant: Mega 1 Company Limited, New Taipei City (TW)

(72) Inventors: Chi-Wei Chen, New Taipei City (TW); Wei-Chih LIN, New Taipei City (TW)

(21) Appl. No.: 16/180,114

(22) Filed: Nov. 5, 2018

(30) Foreign Application Priority Data
Nov. 22, 2017 (TW) 106140458

(51) Int. Cl. G02B 27/01

(52) U.S. Cl. CPC G02B 27/0103; G02B 2027/0174; G02B 27/0149; G02B 27/0172

(57) ABSTRACT

A vehicular head-up display disposed in a vehicle includes an image forming unit disposed on a roof of the vehicle, a reflection mirror disposed below a windshield in the front of the vehicle, and a light shield plate disposed below the windshield, in which the reflection mirror is located between the light shield plate and the windshield. The reflection mirror has a reflection surface facing backward and upward. The light shield plate has a light shield surface facing forward and upward to shield light rays which come from ambient light and are introduced by the reflection surface to enter the vehicle to project onto a user's eyes. Light rays emitted by the image forming unit are reflected by the reflection surface and the windshield to project onto the user's eyes so that the user sees a virtual image formed in front of the windshield.

II

### BACKGROUND OF THE INVENTION

### 1. Field of the Invention

The present invention relates to a vehicular head-up display and, more particularly, to a vehicular head-up display capable of shielding ambient light.

### 2. Description of the Prior Art

Referring to FIG. 1, there is shown a schematic view of a conventional vehicular head-up display 1. The vehicular head-up display 1 is disposed in a vehicle 2 and includes an image forming unit 11 and a reflection mirror 12. The image forming unit 11 is used for generating a real image; the reflection mirror 12 is used for optically reflecting and/or amplifying the real image generated by the image forming unit 11. The image forming unit 11 and the reflection mirror 12 employ a discrete design. Specifically, the image forming unit 11 is disposed on a roof 21 of the vehicle 2. The reflection mirror 12 is disposed below a windshield 22 in the front of the vehicle 2. The reflection mirror 12 has a reflection surface facing backward and upward with respect to the vehicle 2; in the embodiment, the reflection surface of the reflection mirror 12 faces backward arid upward with respect to the vehicle 2 at an angle of 30 degrees from the horizontal. Light rays emitted by the image forming unit 11 are projected onto the reflection surface of the reflection mirror 12; light rays reflected from the reflection surface of the reflection mirror 12 are projected onto the windshield 22; and light rays reflected from the windshield 22 are projected onto a user's eyes E1 so that the user sees a virtual image P1 formed in front of the windshield 22, in which the user may be a driver or a passenger. The virtual image P1 is formed within the driver's field of view while driving so that the driver may pay attention to road conditions and acquire driving information from the virtual image P1 at the same time.

However, as shown in FIG. 2, because the reflection surface of the reflection mirror 12 of the vehicular head-up display 1 faces backward and upward with respect to the vehicle 2, light rays which come from ambient light such as sunlight at some specific angles in some specific directions have chance to be introduced by the reflection face of the reflection mirror 12 to enter the vehicle 2 to project onto the user's eyes E1, resulting in the user's discomfort or even bad effects on driving safety.

### SUMMARY OF THE INVENTION

The present invention is adapted to providing a vehicular head-up display using a geometrical optical structure to shield ambient light to solve the problem of the reflection mirror introducing ambient light to enter the vehicle to directly project onto a user's eyes.

According to an aspect of the present invention, there is provided a vehicular head-up display using a geometrical optical structure to shield ambient light. The vehicular head-up display is disposed in a vehicle and includes an image forming unit, a reflection mirror; and a light shield plate. The image forming unit is disposed on a roof of the vehicle. The reflection mirror is disposed below a windshield in the front of the vehicle. The reflection mirror has a reflection surface facing backward and upward with respect to the vehicle. The light shield plate is disposed below the windshield, and the reflection mirror is located between the light shield plate and the windshield. The light shield plate has a light shield surface facing forward and upward with respect to the vehicle. The light shield plate shields light rays which come from the ambient light and are introduced by the reflection face of the reflection mirror to enter the vehicle to project onto a user's eyes. Light rays emitted by the image forming unit are projected onto the reflection surface of the reflection mirror; light rays reflected from the reflection surface of the reflection mirror are projected onto the windshield; and light rays reflected from the windshield are projected onto the user's eyes so that the user sees a virtual image formed in front of the windshield.

According to another aspect of the present invention, the light shield surface of the light shield plate includes a light absorbing layer formed thereon.

According to another aspect of the present invention, the reflection surface of the reflection mirror is a flat surface or a curved surface.

According to another aspect of the present invention, the reflection surface of the reflection mirror faces backward and upward with respect to the vehicle at an angle of 23 degrees from the horizontal. The light shield surface of the light shield plate faces forward and upward with respect to the vehicle at an angle of 63 degrees from the horizontal. In addition, an end of the reflection surface of the reflection mirror may be connected to an end of the light shield surface of the light shield plate.

The above and other objectives, features, and advantages of the present invention will be better understood from the following detailed description of the preferred embodiments of the present invention that are illustrated in the accompanying drawings.

### BRIEF DESCRIPTION OF THE DRAWINGS

FIG. 1 is a schematic view of a conventional vehicular head-up display;

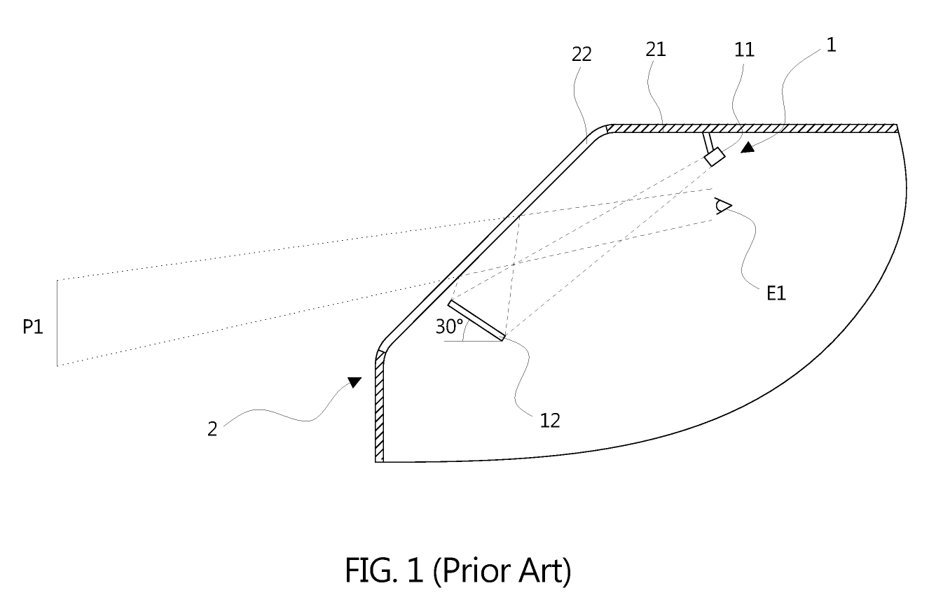

FIG. 2 is a schematic view of ambient light affecting the vehicular head-up display as shown in FIG. 1;

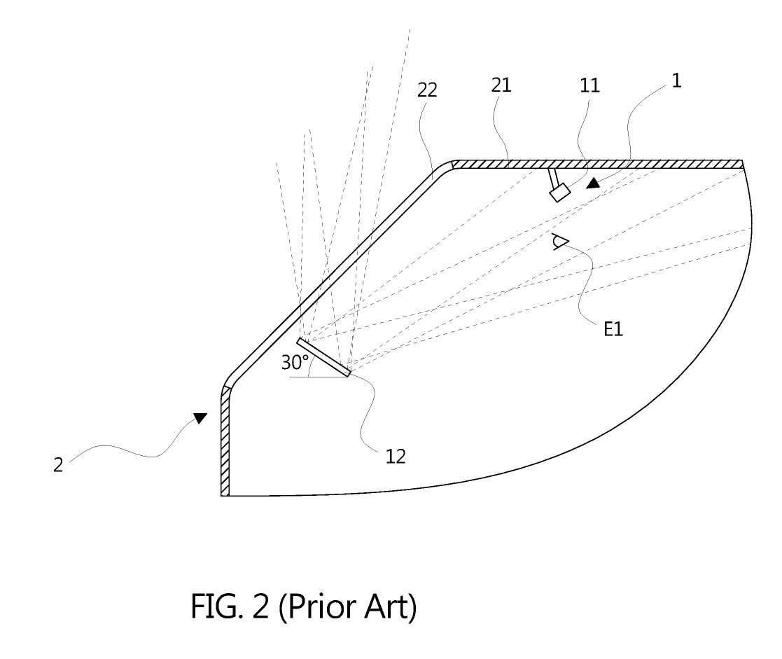

FIG. 3 is a schematic view of a vehicular head-up display according to an embodiment of the present invention; and

FIG. 4 is a schematic view of ambient light affecting the vehicular head-up display as shown in FIG. 3.

### DESCRIPTION OF THE PREFERRED EMBODIMENTS

In the following embodiments, same or similar reference numerals are used in the drawings and the description to refer to the same or like components. Moreover; directional terms, such as up, down, left, right, front, and back are used with respect to the drawings. These and similar directional terms should not be construed to limit the scope of the present invention in any manner.

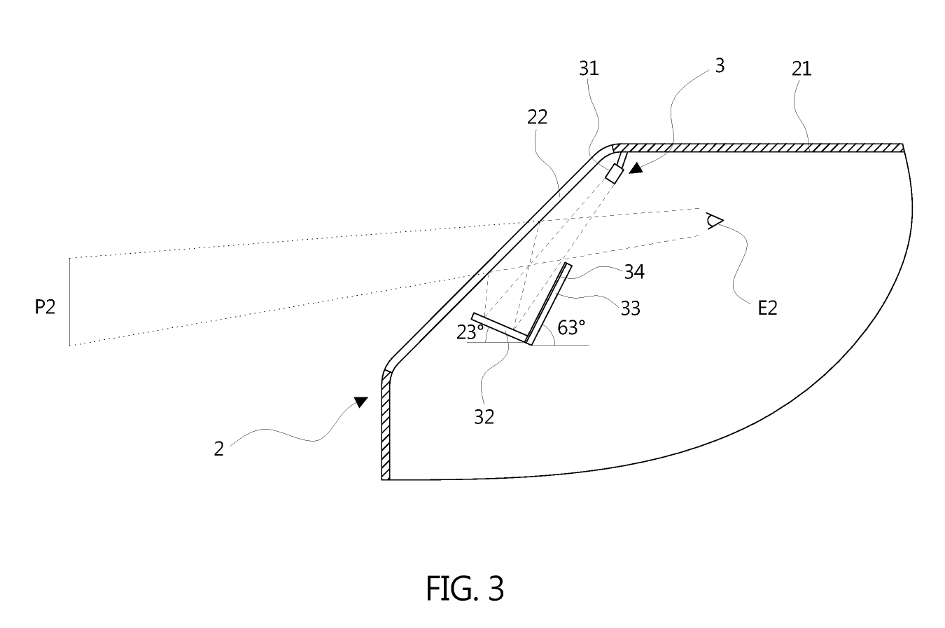

Referring to FIG. 3, there is shown a schematic view of a vehicular head-up display 3 according to an embodiment of the present invention. The vehicular head-up display 3 is disposed in a vehicle 2 and includes an image forming unit 31, a reflection mirror 32, and a light shield plate 33. The image forming unit 31 is used for generating a real image; the reflection mirror 32 is used for optically reflecting and/or amplifying the real image generated by the image forming unit 31; and the light shield plate 33 is used for shielding ambient light introduced by the reflection mirror 32 to enter the vehicle 2. In an embodiment, the image forming unit 31 may be a micro projector employing a laser scanning projection technique, but it is not limited thereto. For example, the image forming unit 31 may be a micro projector employing a Digital Lighting Process (DLP) technique or a Liquid Crystal on Silicon (LCoS) technique. In an embodiment, the reflection surface of the reflection mirror 32 may be a curved surface capable of refocusing the real image from the image forming unit 31, but it is not limited thereto. For example, the reflection surface of the reflection mirror 32 may be a flat surface.

The image forming unit 31, the reflection mirror 32, and the light shield plate 33 employ a discrete design. Specifically, the image forming unit 31 is disposed on a roof 21 of the vehicle 2. The reflection mirror 32 is disposed below a windshield 22 in the front of the vehicle 2. The reflection mirror 32 has a reflection surface facing backward and upward with respect to the vehicle 2; in the embodiment, the reflection surface of the reflection mirror 32 faces backward and upward with respect to the vehicle 2 at an angle of 23 degrees from the horizontal. The light shield plate 33 is disposed below the windshield 22, and the reflection mirror 32 is located between the light shield plate 33 and the windshield 22. The light shield plate 33 has a light shield surface facing forward and upward with respect to the vehicle 2; in the embodiment, the light shield surface of the light shield plate 33 facing forward and upward with respect to the vehicle 2 at an angle of 63 degrees from the horizontal. In the embodiment, an end of the reflection surface of the reflection mirror 32 is connected to an end of the light shield surface of the light shield plate 33, but it is not limited thereto.

Light rays emitted by the image forming unit 31 are projected onto the reflection surface of the reflection mirror 32. Light rays reflected from the reflection surface of the reflection mirror 32 are projected onto the windshield 22. Light rays reflected from the windshield 22 are projected onto the user's eyes E2 so that the user sees a virtual image P2 formed in front of the windshield 22, in which the user may be a driver or a passenger. The virtual image P2 is formed within the driver's field of view while driving so that the driver may pay attention to road conditions and acquire driving information from the virtual image P2 at the same time. It should be noted that the disposition of the light shield plate 33 must not shield the light rays from the image forming unit 31 to the reflection mirror 32 and the light rays from the windshield 22 to the user's eyes E2.

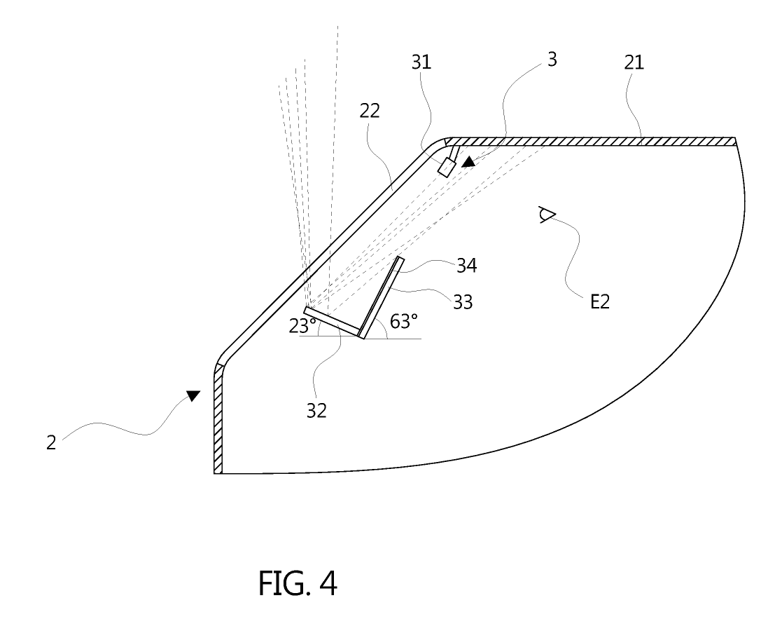

As shown in FIG. 4, because the reflection surface of the reflection mirror 32 of the vehicular head-up display 3 faces backward and upward with respect to the vehicle 2, light rays which come from ambient light such as sunlight at some specific angles in some specific directions have chance to be introduced by the reflection surface of the reflection mirror 32 to enter the vehicle 2, but the entering light rays which have chance to directly project onto the user's eyes E2 will be shielded by the light shield surface of the light shield plate 33 so that no light rays directly project onto the user's eyes E2 and therefore it does not result in the user's discomfort or bad effects on driving safety. It should be noted that, in the embodiment, the light shield surface of the light shield plate 33 includes a light absorbing layer 34 formed thereon. The light absorbing layer 34 may absorb the entering light rays which have chance to be reflected from the light shield plate 33 to project onto the windshield 22 so that it avoids reducing the display quality of the virtual image P2.

Although the present invention has been described in terms of the preferred embodiments, it is not limited thereto. It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A vehicular head-up display using a geometrical optical structure to shield ambient light, disposed in a vehicle, comprising:
an image forming unit disposed on a roof of the vehicle;
a reflection mirror disposed below a windshield in the front of the vehicle, the reflection mirror having a reflection surface facing backward and upward with respect to the vehicle; and
a light shield plate disposed below the windshield, the reflection mirror located between the light shield plate and the windshield, the light shield plate having a light shield surface facing forward and upward with respect to the vehicle, the light shield plate shielding light rays which come from the ambient light and are introduced by the reflection surface of the reflection mirror to enter the vehicle to project onto a user's eyes;
wherein light rays emitted by the image forming unit are projected onto the reflection surface of the reflection mirror; light rays reflected from the reflection surface of the reflection mirror are projected onto the windshield; and light rays reflected from the windshield are projected onto the user's eyes so that the user sees a virtual image formed in front of the windshield.

2. The vehicular head-up display of claim 1, wherein the light shield surface of the light shield plate comprises a light absorbing layer formed thereon.

3. The vehicular head-up display of claim 1, wherein the reflection surface of the reflection mirror is a flat surface.

4. The vehicular head-up display of claim 1, wherein the reflection surface of the reflection mirror is a curved surface.

5. The vehicular head-up display of claim 1, wherein the reflection surface of the reflection mirror faces backward and upward with respect to the vehicle at an angle of 23 degrees from the horizontal.

6. The vehicular head-up display of claim 5, wherein the light shield surface of the light shield plate faces forward and upward with respect to the vehicle at an angle of 63 degrees from the horizontal.

7. The vehicular head-up display of claim 6, wherein an end of the reflection surface of the reflection mirror is connected to an end of the light shield surface of the light shield plate.
